(19) United States
(12) Patent Application Publication
(10) Pub. No.: US 2008/0110721 A1
(43) Pub. Date: May 15, 2008

(54) Roller

(76) Inventor: William Justin, Plant City, FL (US)

Correspondence Address: TY UNG, 16830 VENTURA BLVD., SUITE 360, ENCINO, CA, 91436, US

(21) Appl. No.: 11/985,178

(22) Filed: Nov. 13, 2007

Related U.S. Application Data
(60) Provisional application No. 60/858,803, filed on Nov. 13, 2006.

(51) Int. Cl. B65G 13/00

(52) U.S. Cl. 193/37; 198/780

(57) ABSTRACT

The present invention is an improved design of a roller used in material handling mechanisms such as roller conveyors. The roller is a cylinder having grooves and more particular spiral groove that runs continuously from one end of the roller to the other, covering the entire outer peripheral surface. The groove is formed at a helix or spiral angle.

### CROSS-REFERENCE TO RELATED APPLICATION

This application claims priority to provisional application 60/858,803 filed on Nov. 13, 2006.

### FEDERALLY SPONSORED RESEARCH

Not Applicable

### SEQUENCE LISTING OR PROGRAM

Not Applicable

### BACKGROUND OF THE INVENTION

The present invention relates to rollers, and more particularly to rollers used in roller conveyor system. Roller conveyors are used to transport goods carrier such as pallets and shipping packages. During the conveying operation products rest on the rollers of the roller conveyor. When the rollers are set in motion, the products are moved in the direction of the rollers movement.

The roller conveyors currently on the market generally utilize wheels or rollers without grooves to move products along the conveyor. These traditional rollers due to there shape and design have a tendency to collect foreign objects such as dirt, liquid, and debris. Because of this, there is a need to clean and maintain the traditional rollers frequently. This constant downtime for maintenance causes delays which in turn increases the cost to a company.

Thus, there is a need to provide rollers that require less maintenance but yet provide similar benefits as rollers currently used on roller conveyors.

### SUMMARY OF THE INVENTION

The present invention is an improved design of a roller used in material handling mechanisms such as roller conveyors. The roller is a cylinder having grooves and more particular spiral groove that runs continuously from one end of the roller to the other, covering the entire outer peripheral surface. The groove is formed at a helix or spiral angle.

The spiral design of the groove allows dirt, liquid and other debris to have an exit point at the end of the groove. This keeps the roller surface clean, eliminating the need for cleaning or lubrication.

The spiral design also increases the traction to the goods transported by the roller and avoids slippage and dirt buildup on the surface. It also allows the roller to keep rolling in the proper angle and direction.

### BRIEF DESCRIPTION OF THE FIGURES

FIG. 1 is a perspective view of the roller.

FIG. 2 is an enlarged view showing the groove on the roller.

### FIGURES

### Reference Numerals

10 . . . Roller
12 . . . Groove

### DETAILED DESCRIPTION

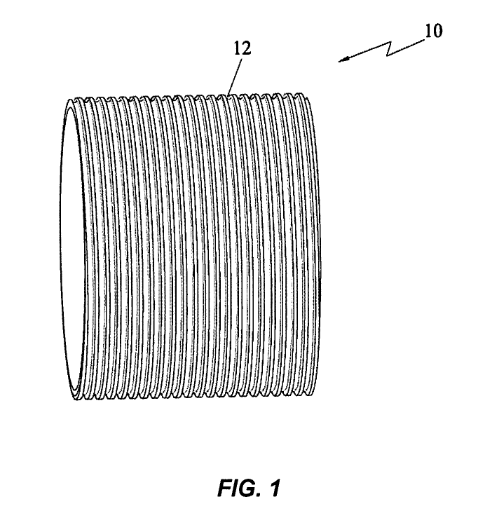

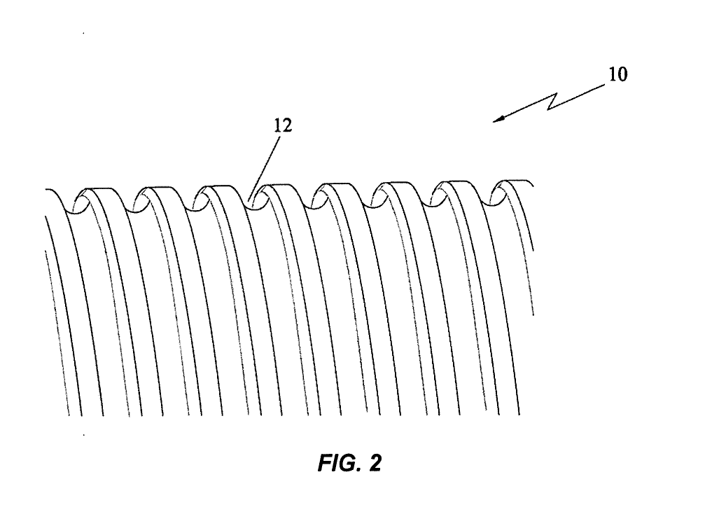

The novel features of the present invention will become apparent from the following description of a preferred embodiment of the invention and as illustrated in FIGS. 1 and 2. The present invention is an improved design of a roller used in material handling systems such as roller conveyors.

Referring to FIGS. 1 and 2, the roller 10 is a cylinder having a spiral groove 12 running continuous, starting from one end of the roller to the other, covering the entire outer peripheral surface. The groove is formed at a helix or spiral angle.

The spiral design of the groove allows dirt, liquid and other debris to have an exit point at the end of the groove. This keeps the roller surface clean, eliminating the need for cleaning or lubrication.

The spiral design increases the traction on goods transported by the roller and avoids slippage and dirt buildup on the surface. It also allows the roller to keep rolling in the proper angle and direction. The roller can be made with materials such as Nylatron, plastic, or rubber. The attachment means for connecting the roller to the material handling systems is similar to attachment means used in rollers currently used for the same purpose.

The roller can be made in different sizes. In a preferred embodiment, the outer diameter of the roller can range from ½ inch to 6 inches and the spiral groove is ¼ inch in size. The roller is preferably used in package handling services or other conveyor transport systems similar to the wheel roller used on conveyors for handling packages by companies such as UPS.

To use the roller, the rollers are installed at locations where traditional rollers or wheels are installed on the material handling system. Once installed, the material handling system with the new rollers is operated in the same manner as with the traditional rollers or wheels. However, because of the groove, there is less need to clean and maintain the roller as any foreign objects such as liquid, dirt, or debris are removed from the roller by the spiral. The spiral provides an exit for these foreign objects to pass to the circumference of the roller.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

While specific systems and methods have been disclosed in the preceding description, it should be understood that these specifics have been given for the purpose of disclosing the principles of the present invention and that many variations thereof will become apparent to those who are versed in the art.

What is claimed is:

1. A roller for use in material handling system comprising:
Groove on the outer surface of the roller.

2. The roller of claim 1, wherein the groove spirals helically from one end of the roller to the other end.

3. The roller of claim 1, wherein the roller is cylindrical.

4. The roller of claim 1, wherein the roller is made nylatron.

5. The roller of claim 1, wherein the roller is made of plastic.

6. The roller of claim 1, wherein the roller is made of rubber.

7. The roller of claim 1, wherein the diameter of the roller range from ½ inch to 6 inches in diameter.

8. The roller of claim 1, wherein the groove is ¼ inch in size.

9. The roller of claim 2, wherein the spiral groove is ¼ inch in size.

10. The roller of claim 9, wherein the diameter of the roller range from ½ inch to 6 inches in diameter.

11. The roller of claim 10, wherein the roller is made of plastic.

12. The roller of claim 10, wherein the roller is made of rubber.

13. The roller of claim 10, wherein the roller is made of nylatron.

14. The roller of claim 2, wherein the roller is cylindrical.

15. The roller of claim 1, further comprising attachment means similar to attachment means on rollers presently used on material handling system.

16. The roller of claim 15, wherein the groove spirals helically from one end of the roller to the other end.

17. The roller of claim 16, wherein the roller is made of nylatron.

18. The roller of claim 16, wherein the roller is made of plastic.

19. A material handling system using grooved rollers of the present invention.

20. A method of using a roller with spiral groove, comprising the step of:
(a) Installing the roller on a material handling system at locations for the installation of traditional roller;
(b) Using the material handling system to move materials along the material handling system.
